(19) United States
(12) Patent Application Publication
(10) Pub. No.: US 2009/0014996 A1
(43) Pub. Date: Jan. 15, 2009

(54) Reverse Printed Book

(76) Inventor: Anya Verkhovskaya, Mequon, WI (US)

Correspondence Address: WHYTE HIRSCHBOECK DUDEK S C;INTELLECTUAL PROPERTY DEPARTMENT, 555 EAST WELLS STREET, SUITE 1900, MILWAUKEE, WI, 53202, US

(21) Appl. No.: 12/170,026

(22) Filed: Jul. 9, 2008

Related U.S. Application Data
(60) Provisional application No. 60/948,750, filed on Jul. 10, 2007.

(51) Int. Cl. B42D 1/00

(52) U.S. Cl. 281/15.1

(57) ABSTRACT

A book for children, comprising at least two pages, is constructed such that each page has a front face comprising a first location of written text. The book further comprises a second location of the same written text that is not located on the front face of the same page comprising the first location, wherein the book is adapted such that, when the book is interposed directly in a line of sight between a first viewer and a second viewer, the first viewer views the first location of written text on the front face of the page simultaneously with the second viewer viewing the second location of the same written text.

### BACKGROUND OF THE INVENTION

This invention relates generally to printing, and more specifically to methods and apparatus for reading books to another person or persons.

Teachers, caregivers, and parents frequently read books aloud to children. Typically, children's books have drawings, pictures, or other illustrations to keep the child's interest. The text of such books is ordinarily superimposed over, or printed next to, the illustrations. As such, the reader of the book must have the page facing him or her. When the page is facing the reader, the child or children may not be able to view the illustrations. If the child cannot see the illustrations while the text is being read, then the illustrations will not be as effective in reinforcing the story or in keeping the child interested in the story.

### BRIEF SUMMARY OF THE INVENTION

This invention provides a convenient means for a reader to read written text while allowing another person, child, or a group of children to simultaneously view the text and illustrations. The invention is a book for children comprising at least two pages or more, each page having a front face comprising a first location of written text next to the main illustration. The book further comprising a second location:
1. on the front face of the same page comprising the first location;
2. on the back cover of the book; or
3. be inserted into a pocket of the back cover of a book;
   of the same written text next to a smaller version of the main illustration for the first viewer to know what the second viewer is looking at. The back cover or an insert(s) will contain text from all pages of the book next to appropriate small versions of illustrations as well as page numbers (page numbers should also be printed on the upper further corner of the book for the reader to see it easily). Wherein the book is adapted such that, when the book is interposed directly in a line of sight between a first viewer and a second viewer, the first viewer views the first location of written text and an illustration on the front face of the page simultaneously with the second viewer viewing the second location of the same written text and a smaller version of an illustration.

This invention could also be adopted for electronic books where the reader uses an electronic pen to follow the words on the reader's page while the text in the first location is being highlighted (electronically), so the children can learn the words that are read.

### BRIEF DESCRIPTION OF THE DRAWINGS

Preferred embodiments of the invention are described below with reference to the following accompanying drawings, which are for illustrative purposes only. Throughout the following views, reference numerals will be used in the drawings, and the same reference numerals will be used throughout the several views and in the description to indicate same or like parts or steps.

FIG. 1 shows a typical prior art children's book.

FIG. 2A shows the front of page of a book according to one embodiment of the current invention.

FIG. 2B shows the reverse of the page of FIG. 2A.

FIG. 3 shows an open loose-leaf book of the current invention.

FIG. 4 shows a top view of the book of FIG. 3 in a reading arrangement.

### DETAILED DESCRIPTION OF THE INVENTION

In the following detailed description, references made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that changes may be made without departing from the spirit and scope of the present invention.

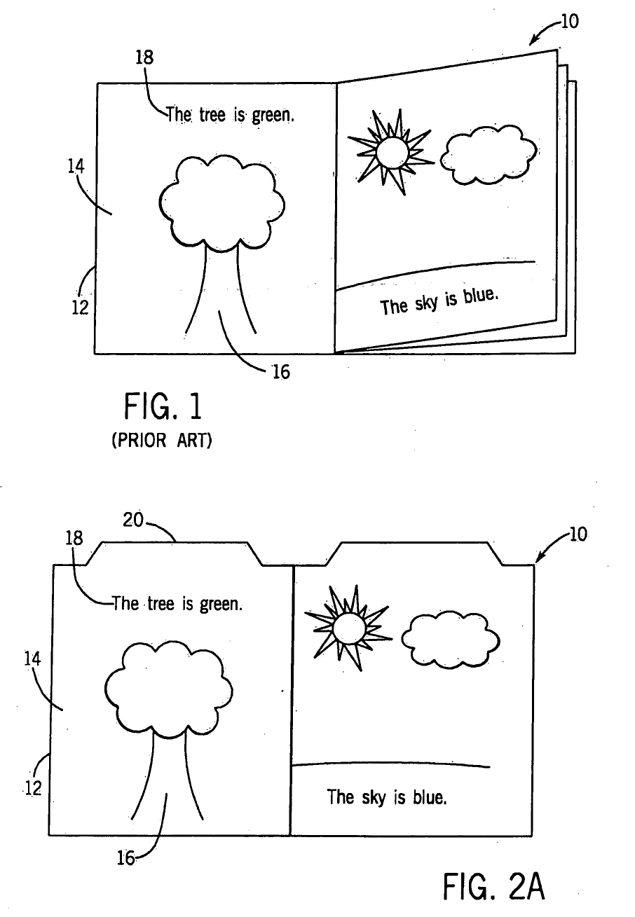

Children's books typically have illustrations and related simple text that conveys the same concept. In the typical bound or stapled book 10, as shown in FIG. 1, each page 12 may have a picture 16 and a simple verse 18 on the front face 14. Occasionally, the picture 16 and related text 18 may extend across two facing pages. When such a book is read, only persons on the same side of the plane, defined by the page 12, as the reader can view the illustrations. Additionally, such persons would also have to be in close proximity with the reader in order to have good viewing lines. Such positioning may be acceptable when reading to one child or a small number of children who can sit on the reader's lap or by the reader's side. However, for larger groups, or when such close proximity is not desired (for instance, when reading to a child who is in bed), the reader must alternately position the book to face him or her and then turn the book over to face the audience. In this manner, the child or children cannot simultaneously hear the text and see the illustrations. Consequently, the reinforcement obtained by simultaneous viewing of the illustrations while hearing the text is lost and the child's attention may be more easily lost.

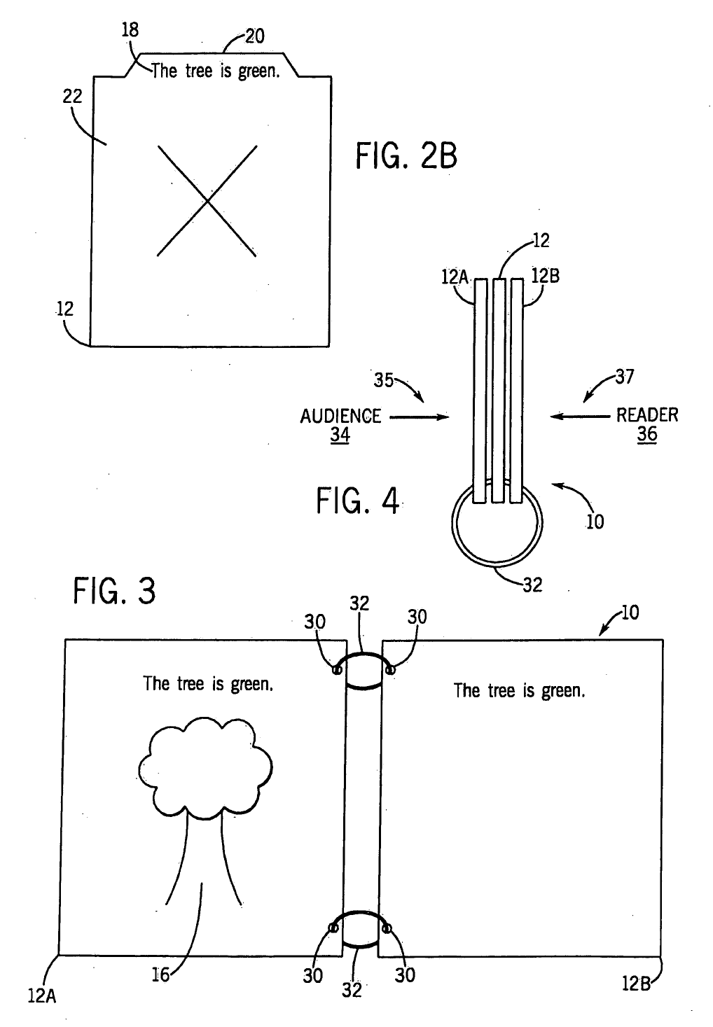

In one embodiment of the invention, the book 10 is bound or stapled as shown in FIG. 2A. Pages 12 have a front side 14 on which illustrations 16 and a first location of text 18 are displayed. Pages 12 also comprise a tab 20 extending beyond one side or end of the page 12. FIG. 2B shows the back side 22 of page 12 and of tab 20. On the back side 22 of tab 20 is a second location of the same text 18 as displayed in the first location on the front side 14 of page 12. In this embodiment, a reader may hold the book 10 in an orientation such that the front side 14 of page 12 faces toward the intended audience while the back side 22 of tab 20 faces the reader. Consequently, the intended audience can view both the first location of text 18 and illustration 16 simultaneously with hearing the reader recite text 18 (by reading from the back side 22 of tab 20). In multi-page books, tabs 20 would be staggered along the length of the page end or side to allow the reader to view each tab in turn.

In another embodiment of the invention, the book 10 would be printed and configured like the prior art book 10 shown in FIG. 1. In this embodiment, the second location of text 18 for each page 12 would be printed on the cover of the book (not shown). Again the reader and the intended audience can view both the first location of text 18 and illustration 16 simultaneously with hearing the reader recite text 18 (by reading from the cover of the book). Optionally, tabs, like tab 20, having page numbers, could be placed on the pages 12 in order to facilitate the reader coordinating the text with the page.

In another embodiment of the invention, the book 10 comprises loose leaf pages 12 held together by binding means 32 comprising a spiral wire or one or more rings as shown in FIG. 3. Each page 12 has one or more holes 30 through which binding means 32 passes, thereby allowing pages 12 to slide along binding means 32. In the position shown in FIG. 3, page 12A and 12B are facing pages. Page 12A comprises an illustration 16 and a first location of text 18. Page 12B comprises a second location of text 18. As shown in FIG. 4, the pages 12 of book 10 can be moved along binding means 32 such that all of the pages are essentially stacked. In this arrangement, the book 10 can be held between an audience 34 and a reader 36. The page 12A is then in the line of sight 35 of the audience 34 allowing the audience 34 to view the illustration 16 and the first location of the text 18. Likewise, page 12B is then in the line of sight 37 of reader 36 allowing the reader 36 to view the second location of text 18. Again, this embodiment permits the audience 34 to view the illustration 16 and the first location of the text 18 while simultaneously hearing the reader 36 recite the text 18 by reading from the second location of that text located on page 12B.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. A book for children comprising at least two pages, each page having a front face comprising a first location of written text, the book further comprising a second location of the same written text that is not located on the front face of the same page comprising the first location, wherein the book is adapted such that, when the book is interposed directly in a line of sight between a first viewer and a second viewer, the first viewer views the first location of written text on the front face of the page simultaneously with the second viewer viewing the second location of the same written text.

2. The book of claim 1, wherein the pages are connected at least along a side of each page or at a corner of each page.

3. The book of claim 2, wherein the pages are bound together along a side of each page.

4. The book of claim 2 wherein the pages are connected by means of spiral or ring bindings.

5. The book of claim 1, wherein the page further comprises a back face opposite the front face and the back face comprises the second location.

6. The book of claim 1, wherein the page further comprises at least one tab.

7. The book of claim 6, wherein the tab has a front face corresponding to the front face of the page and a back face corresponding to the back face of the sheet and wherein the back face of the tab comprises the second location.

8. A book for children comprising a multiplicity of pages slidably engaged with a binding means, wherein each page has a front face and a back face and the back face of one page faces the front face of an immediately following next page when the book is in a closed or partially closed position, wherein the back face of a page comprises a first location of written text and the front face of the immediately following next page comprises a second location of the same written text.

9. The book of claim 8, wherein the binding means is one or more rings or a spiral wire.

10. The book of claim 8, wherein the pages can slide along the binding means such that all pages can be placed in a single stack on top of each other and the stack can be rearranged by sliding the pages such that the page on top of the stack can be changed.

11. The book of claim 10, wherein the page on the top of the stack is orientated with the back face opposite the stacked pages, the page on the bottom of the stack is considered the immediately following next page and is orientated with the front face opposite the stacked pages.

12. The book of claim 8, wherein the book is adapted such that, when the book is interposed directly in a line of sight between a first viewer and a second viewer, the first viewer views the first location of written text on the back face of the page but cannot view the second location of the written text and the second viewer views the second location of the written text but cannot view the first location of the written text.
